(19) United States
(12) Patent Application Publication
(10) Pub. No.: US 2026/0291390 A1
(43) Pub. Date: Sep. 24, 2026

(54) HYSTERETIC CURRENT MODE BUCK-BOOST CONVERTER

(71) Applicant: TEXAS INSTRUMENTS INCORPORATED, Dallas, TX (US)

(72) Inventors: Jian Liang, Shanghai (CN); Zhekai Xiao, Xiamen (CN); Chaofan Du, Wuxi (CN)

(21) Appl. No.: 19/085,356

(22) Filed: Mar. 20, 2025

(51) Int. Cl. H02M 3/158; H02M 3/157

(52) U.S. Cl. CPC H02M 3/1582; H02M 3/157

(57) ABSTRACT

An apparatus comprises a current source configurable to provide a first current at a pre-determined current value. The apparatus further comprises a first current comparator configurable to receive a rising current through an inductor as a first input and the first current plus a second current as a second input and provide an output to a control logic based on comparison between the two inputs. The apparatus further comprises a second current comparator configurable to receive the second current as a first input and a falling current through the inductor as a second input and provide an output to the control logic based on comparison between its two inputs. The apparatus further comprises the control logic configurable to control an inductor current through the inductor by switching one or more of a plurality of transistors based on the outputs from the first current comparator and the second current comparator.

### BACKGROUND

Low voltage buck-boost converters are widely used in Li-ion battery powered devices such as smart phones and tablets. Buck-boost converters are also used in optical module systems, which provide an accurate voltage rail when input DC voltage has a big variation. A buck-boost converter typically includes four switch transistors, e.g., field-effect transistors (FETs), and has a lower efficiency when operating under a 4-FET switching buck-boost mode compared to a 2-FET switching buck or boost converter. When operating under the buck or boost mode, the operations of the buck-boost converter is often limited by its duty cycle, especially under high switching frequency. For a nonlimiting example, with 4 MHz switching frequency, the time period of a buck-boost converter is 250 ns, and its duty cycle is between 20% to 80% with minimum ON time (T_{ON}) and OFF time (T_{OFF}) of 50ns each. Under such duty cycle limitation, the input voltage to the buck-boost converter Vᵢₙ is between 2.72V and 4.25V for an output voltage Vₒᵤₜ of 3.4V. As a result, the buck-boost converter has to operate in the low efficiency buck-boost mode for almost the entire Li-ion battery voltage range.

In addition, mode transition between buck/buck-boost/boost modes of a buck-boost converter is currently complex, usually requiring Vᵢₙ/Vₒᵤₜ voltage information and min/max duty cycle as mode transition condition. Current overshoot and output voltage ripple also happen during the mode transition. Furthermore, the min/max duty cycle of the buck-boost converter may be triggered during a transient event, causing extra delay time that is needed to prevent potential unexpected mode transition due to the triggered min/max duty cycle.

### SUMMARY

In an example, an apparatus comprises a current source configurable to provide a first current at a pre-determined current value. The apparatus further comprises a first current comparator configurable to receive a rising current through an inductor as a first input of the first current comparator and the first current plus a second current as a second input of the first current comparator, and provide an output to a control logic based on comparison between the first input and the second input of the first current comparator. The apparatus further comprises a second current comparator configurable to receive the second current as a first input of the second current comparator and a falling current through the inductor as a second input of the second current comparator, and provide an output to the control logic based on comparison between the first input and the second input of the second current comparator. The apparatus further comprises the control logic configurable to control an inductor current through the inductor by switching one or more of a plurality of transistors based on the outputs from the first current comparator and the second current comparator.

In another example, a method comprises generating a first current at a pre-determined current value. The method further comprises receiving a rising current through an inductor as a first input of a first current comparator and the first current plus a second current as a second input of the first current comparator, and providing an output to a control logic based on comparison between the first input and the second input of the first current comparator. The method further comprises receiving the second current as a first input of a second comparator and a falling current through the inductor as a second input of the second current comparator, and providing an output to the control logic based on comparison between the first input and the second input of the second current comparator. The method further comprises controlling an inductor current through the inductor by switching one or more of a plurality of transistors based on the outputs from the first current comparator and the second current comparator.

### BRIEF DESCRIPTION OF THE DRAWINGS

FIG. 1 is a schematic diagram of a hysteretic current mode buck-boost converter, which utilizes a hysteretic current source to control inductor current switching, in an example.

FIG. 2A depicts a schematic diagram of an implementation of a mode controller in FIG. 1, in an example. FIG. 2B depicts transitioning among the buck mode, the boost mode, and the buck-boost mode as controlled by the mode controller, in an example.

FIG. 3 depicts examples of waveforms of the inductor current IL over time under the buck mode, the buck-boost mode, and the boost mode, respectively.

FIG. 4A depicts a schematic diagram of an implementation of the skip timer in FIG. 1, in an example. FIG. 4B depicts relationship between the second current I_{EA} and the skip period of time T_{SKIP}, in an example.

FIG. 5 depicts examples of waveforms of the inductor current IL over time under the buck mode, the buck-boost mode, and the boost mode, respectively, with the skip timer skips the skip period of time T_{SKIP}.

### DETAILED DESCRIPTION

The same reference numbers or other reference designators are used in the drawings to designate the same or similar (either by function and/or structure) features.

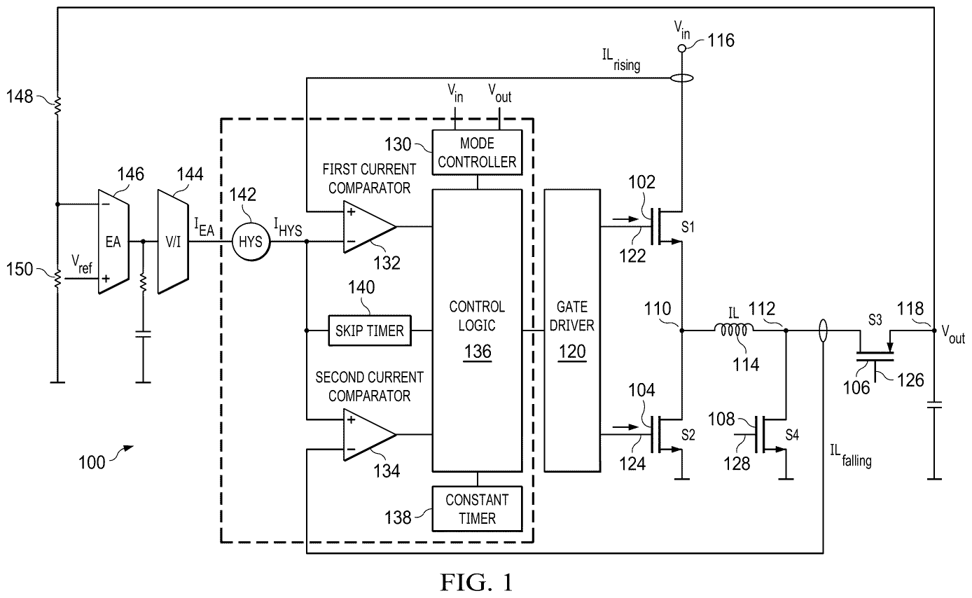

FIG. 1 is an illustrative example of a schematic diagram of a hysteretic current mode buck-boost converter 100, which utilizes a hysteretic current source 142 to control inductor current switching. As shown in the example of FIG. 1, the hysteretic current mode buck-boost converter 100 includes a plurality of switching FETs, e.g., 4 switching FETs 102, 104, 106, and 108. In one example, a first (buck high side or HS) FET S1/102 is coupled between a voltage input terminal 116 and a first terminal 110, and a second (buck low side or LS) FET S2/104 is coupled between the first terminal 110 and a ground terminal, wherein the voltage input terminal 116 is connected to an input voltage Vᵢₙ of the hysteretic current mode buck-boost converter 100. In one example, a third (boost HS) FET S3/106 is coupled between a voltage output terminal 118 and a second terminal 112, and a fourth (boost LS) FET S4/108 is coupled between the second terminal 112 and the ground terminal, wherein the voltage output terminal 118 is connected to an output voltage Vₒᵤₜ of the hysteretic current mode buck-boost converter 100. In one example, gate terminals 122, 124, 126, and 128 of the first, second, third, and fourth FETs 102, 104, 106, and 108, respectively, are controlled by the control logic 136 via a gate driver 120 to switch the four FETs on and off as discussed in details below. In one example, an inductor 114 is coupled between the first terminal 110 and the second terminal 112.

In the example of FIG. 1, the hysteretic current mode buck-boost converter 100 includes a first current comparator 132 configurable to receive as its first current input, a current IL_{rising} flowing through the first transistor 102 from the voltage input terminal 116. In one example, the first current comparator 132 is configurable to receive as its second current input, a combination of two currents—a first current I_{HYS} and a second current I_{EA}. The first current comparator 132 is configurable to compare its two current inputs and to provide an output to the control logic 136 based on the comparison between its two inputs. In one example, the first current I_{HYS} is provided by a hysteretic current source 142, which provides the first current I_{HYS} at a value pre-determined by a user, wherein the pre-determined first current I_{HYS} defines/controls the range of the inductor current IL flowing through the inductor 114 via current feedback loops of as discussed in details below. In one example, the second current I_{EA} is generated from the output voltage Vₒᵤₜ. Specifically, a fraction of the output voltage Vₒᵤₜ as divided by a pair of resistors 148 and 150 is provided as an input to an error amplifier (EA) 146 to be compared to a reference voltage V_{ref}. The output from the EA 146 is then converted to the second current I_{EA} by a voltage-current (V/I) converter 144.

In the example of FIG. 1, the hysteretic current mode buck-boost converter 100 includes a second current comparator 134 configurable to receive as its first current input, the second current I_{EA} generated according to the output voltage Vₒᵤₜ as discussed above. The second current comparator 134 is also configurable to accept as its second current input, a current IL_{falling} flowing through the third transistor 106 from the voltage output terminal 118. The second current comparator 134 is then configurable to compare its two current inputs and to provide an output to the control logic 136 based on the comparison between its two inputs.

In the example of FIG. 1, the hysteretic current mode buck-boost converter 100 includes a mode controller 130 configurable to accept the input voltage Vᵢₙ from the input voltage terminal 116 and the output voltage Vₒᵤₜ from the output voltage terminal 118, respectively, as its two inputs, and generate an output to the control logic 136 to switch one or more of the first, the second, the third, and the fourth FETs 102, 104, 106, 108, respectively, among a buck mode, a boost mode, and a buck-boost mode. Specifically, the mode controller 130 is configurable to turn on the third FET 106, turn off the fourth FET 108, and allow switching between the first FET 102 and the second FET 104 via the control logic 136 during the buck mode. In one example, the mode controller 130 is configurable to turn on the first FET 102, turn off the second FET 104, and allow switching between the third FET 106 and the fourth FET 108 via the control logic 136 during the boost mode. In one example, the mode controller 130 is configurable to allow switching among all of the first FET 102, the second FET 104, the third FET 106 and the fourth FET 108 via the control logic 136 during the buck-boost mode.

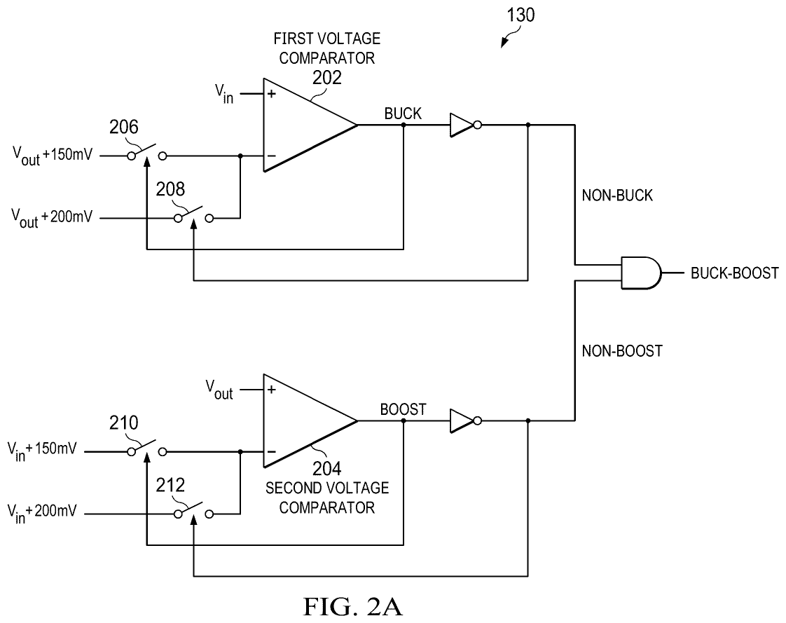

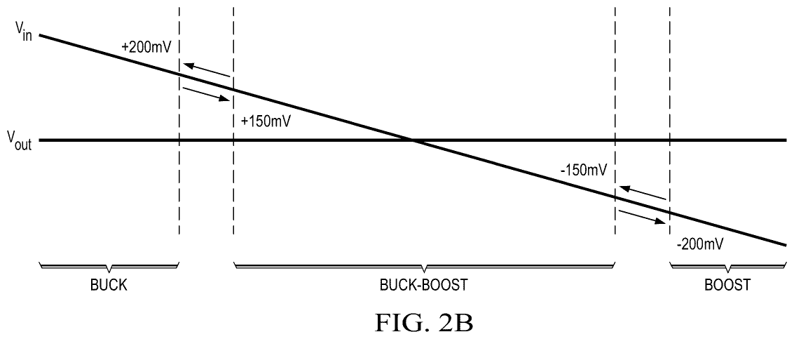

FIG. 2A depicts an example of a schematic diagram of an implementation of the mode controller 130 in FIG. 1 and FIG. 2B depicts transitioning among the buck mode, the boost mode, and the buck-boost mode as controlled by the mode controller 130 based on the input voltage Vᵢₙ and the output voltage Vₒᵤₜ. As shown by the example of FIG. 2A, the mode controller 130 includes a first voltage comparator 202, which takes the input voltage Vᵢₙ as its first input and the output voltage Vₒᵤₜ plus ΔV₁ (e.g., 150 mV or 200 mV) as its second input. The mode controller 130 also includes a second voltage comparator 204, which takes the output voltage Vₒᵤₜ as its first input and the input voltage Vₒᵤₜ plus ΔV₂ (e.g., 150 mV or 200 mV) as its second input. In one example, the mode controller 130 is configurable to output three mode signals to the control logic 136, BUCK, BOOST, and BUCK-BOOST, for switching to buck mode, boost mode, and buck-boost mode, respectively, with one and only one of the three mode signals being high/ON at any time.

Assuming that the hysteretic current mode buck-boost converter 100 starts initially in the buck mode, where Vᵢₙ is greater than Vₒᵤₜ+ΔV 1 (e.g., 150 mV) as shown in FIG. 2B. As a result, the BUCK signal generated by the first voltage comparator 202 based on Vᵢₙ and Vₒᵤₜ+150 mV is ON and so is the switch 206 as shown in FIG. 2A. As Vᵢₙ drops to be less than Vₒᵤₜ+150 mV, the hysteretic current mode buck-boost converter 100 enters the buck-boost mode as the BUCK signal is OFF and the BUCK-BOOST signal is ON as both the BUCK signal and the BOOST signal are OFF (and NON_BUCK and NON_BOOST signals are ON). While in the buck-boost mode, if Vᵢₙ reverses its trend and rises to be greater than, e.g., Vₒᵤₜ+200 mV (with switch 208 being ON), the BUCK signal becomes ON again and the hysteretic current mode buck-boost converter 100 moves back to the buck mode. If, on the other hand, Vᵢₙ continues to fall and drops below, e.g., Vₒᵤₜ−200 mV (with switch 212 being ON) in the buck-boost mode, the BOOST signal generated by the second voltage comparator 204 is ON and the hysteretic current mode buck-boost converter 100 enters the boost mode. If Vin again reverses and rises above, e.g., Vₒᵤₜ−150 mV (with switch 210 being ON), the BUCK-BOOST signal becomes ON again and the hysteretic current mode buck-boost converter 100 moves back to the buck-boost mode. As such, the hysteretic current mode buck-boost converter 100 can switch among the buck mode, the buck-boost mode, and the boost mode depending solely on the input voltage Vᵢₙ and the output voltage Vₒᵤₜ and not subject to any duty cycle limitations. As a result, better control of the operation mode is achieved. Better control of the operation mode may be based on an application. For example, certain optical module customers may now operate the hysteretic current mode buck-boost converter 100 in the buck-boost mode for certain/desired input voltage range.

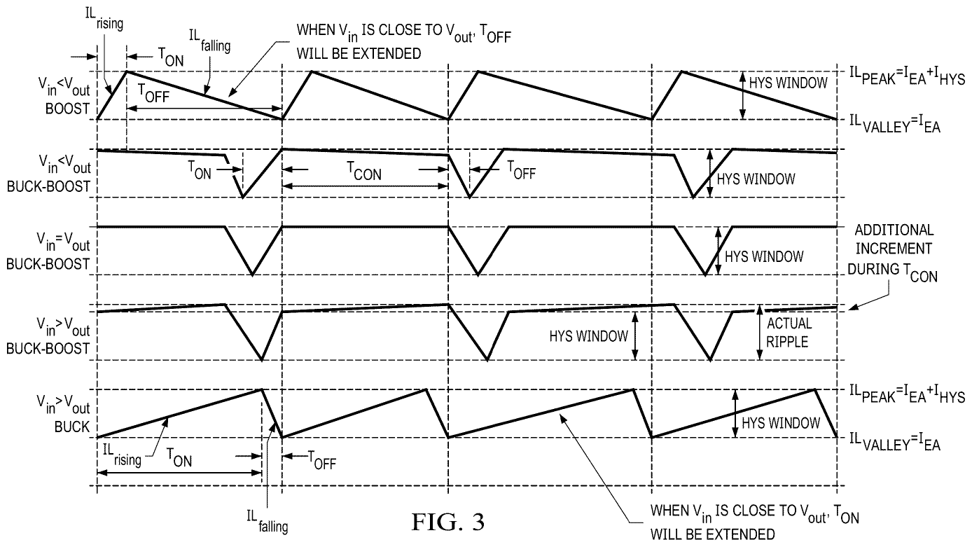

In the example of FIG. 1, the control logic 136 is configurable to control an inductor current IL through the inductor 114 by switching one or more of the plurality of FETs, e.g., 102, 104, 106, and 108, based on outputs from the first current comparator 132, the second current comparator 134 under the buck mode, the buck-boost mode, and the boost modem respectively. FIG. 3 depicts examples of waveforms of the inductor current IL over time under the buck mode, the buck-boost mode, and the boost mode, respectively. Specifically, as shown in FIG. 3, when the hysteretic current mode buck-boost converter 100 in FIG. 1 operates in the buck mode, e.g., Vᵢₙ is greater than Vₒᵤₜ, the control logic 136 is configurable to turn on the third FET 106, turn off the fourth FET 108, and to switch between the first FET 102 and the second FET 104 by sending corresponding control signals to their respective gate terminals 126, 128, 122, and 124 via the driver 120. When the first FET 102 is switched on, the hysteretic current mode buck-boost converter 100 is in T_{ON} period with the rising inductor current IL equals to IL_{rising} flowing through the first FET 102, the inductor 114, and the third FET 106 with di/dt=(Vᵢₙ−Vₒᵤₜ)/L, wherein L is the inductance of the inductor 114. Once the inductor current IL_{rising} reaches and exceeds IL_{PEAK}=I_{EA}+I_{HYS}, the first current comparator 132 sends a signal to the control logic 136 to turn off the first FET 102 and to turn on the second FET 104, and the hysteretic current mode buck-boost converter 100 enters T_{OFF} period. During this time, the inductor current IL equaling to IL_{falling} is falling with di/dt=Vₒᵤₜ/L until it reaches IL_{VALLEY}=I_{EA}, which triggers the second current comparator 134 to send a signal to the control logic 136 to turn off the second FET 104 and to turn on the first FET 102 so that the inductor current IL will start rising again. As such, the control logic 136 loop controls the inductor current IL rippling between the peak current IL_{PEAK} and the valley current IL_{VALLEY} within a range/window of the ripple (hysteretic) current I_{HYS} generated by hysteretic current source 142, wherein the hysteretic current I_{HYS} is a design/constant value pre-set by the designer/user of the hysteretic current mode buck-boost converter 100. By setting the hysteretic current I_{HYS} properly, the T_{ON} period of the hysteretic current mode buck-boost converter 100 can be extended under the buck mode when Vᵢₙ is close to Vₒᵤₜ even when the minimum T_{OFF} period is reached, thus breaking the duty cycle limitations under the hysteretic current mode. Without the duty cycle limitation, the buck and boost mode operation range can be extended to achieve higher efficiency.

When the hysteretic current mode buck-boost converter 100 operates in the boost mode, e.g., Vᵢₙ is less than Vₒᵤₜ, the control logic 136 is configurable to turn on the first FET 102, turn off the second FET 104, and to switch between the third FET 106 and the fourth FET 108 by sending corresponding control signals to their respective gate terminals 122, 124, 126, and 128 via the driver 120. When the fourth FET 108 is switched on, the hysteretic current mode buck-boost converter 100 is in T_{ON} period with the rising inductor current IL equals to IL_{rising} flowing through the first FET 102, the inductor 114, and the fourth FET 108 with di/dt=Vᵢₙ/L. Once the inductor current IL_{rising} reaches and exceeds IL_{PEAK}=I_{EA}+I_{HYS}, the first current comparator 132 sends a signal to the control logic 136 to turn off the fourth FET 108 and to turn on the third FET 106, and the hysteretic current mode buck-boost converter 100 enters T_{OFF} period. During this time, the inductor current IL equaling to IL_{falling} is falling with di/dt=(Vₒᵤₜ−Vᵢₙ)/L until it reaches IL_{VALLEY}=I_{EA}, which triggers the second current comparator 134 to send a signal to the control logic 136 to turn off the third FET 106 and to turn on the fourth FET 108 so that the inductor current IL will start rising again. As in the case of the buck mode, the control logic 136 loop controls the inductor current IL rippling between the peak current IL_{PEAK} and the valley current IL_{VALLEY} within a range/window of the ripple (hysteretic) current I_{HYS}. By setting the I_{HYS} properly, the T_{OFF} period of the hysteretic current mode buck-boost converter 100 can be extended under the boost mode when Vᵢₙ is close to Vₒᵤₜ even when minimum T_{ON} period is reached, thus breaking the duty cycle limitations under the hysteretic current mode.

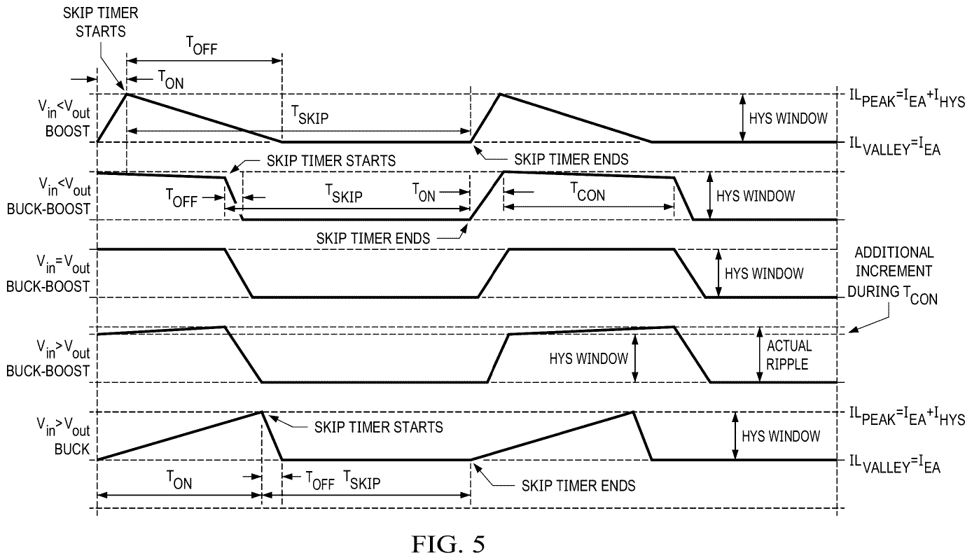

When the hysteretic current mode buck-boost converter 100 operates in the buck-boost mode, i.e., Vᵢₙ can be either greater, less, or equal to Vₒᵤₜ, the control logic 136 is configurable to switch among all of the first FET 102, the second FET 104, the third FET 106 and the fourth FET 108 by sending corresponding control signals to their respective gate terminals 122, 124, 126, and 128 via the driver 120. When the first FET 102 and the fourth FET 108 are switched on, the hysteretic current mode buck-boost converter 100 is in the T_{ON} period with the rising inductor current IL equals to IL_{rising} flowing through the first FET 102, the inductor 114, and the fourth FET 108 with di/dt=Vᵢₙ/L. Once the inductor current IL_{rising} reaches IL_{PEAK}=I_{EA}+I_{HYS}, the first current comparator 132 sends a signal to the control logic 136 to switch off the fourth FET 108 and turn on the third FET 106, and the hysteretic current mode buck-boost converter 100 enters T_{CON} period with the first FET 102 and the third FET 106 being on. During the T_{CON} period, the inductor current IL is held close to its current level (e.g., IL may be equal to or change with a small slope from its current level) because Vᵢₙ and Vₒᵤₜ are expected to be close in the buck-boost mode. In one example, the hysteretic current mode buck-boost converter 100 includes a constant timer 138 as shown in FIG. 1, wherein the constant timer 138 is configurable to provide an output to the control logic 136 to hold the inductor current IL close to its current level for a certain period of time (T_{CON}) between the first time period T_{ON} when the inductor current IL is rising and the second time period T_{OFF} when the inductor current IL is falling to increase buck-boost efficiency. In one example, T_{CON} is a design value set by the designer, wherein T_{CON} can be but is not limited to 200~500ns. In one example, the value of T_{CON} (fixed or adaptive) is chosen by taking into consideration values of one or more of I_{HYS}, L, Vᵢₙ, Vₒᵤₜ, and desired switching frequency, etc. In one example, the constant timer 138 is a fixed timer without input from any of the current or voltage sources. Following the T_{CON} period, the control logic 136 turns off the first FET 102 and turns on the second FET 104, and the hysteretic current mode buck-boost converter 100 enters T_{OFF} period with the inductor current IL equals to IL_{falling} with di/dt=Vₒᵤₜ/L with the second FET 104 and the third FET 106 being on until IL_{falling} reaches IL_{VALLEY}=I_{EA}. At this time, the second current comparator 134 sends a signal to the control logic 136 to turn off the second FET 104 and the third FET 106 and to turn on the first FET 102 and the fourth FET 108 so that the inductor current IL will start rising again. As in the case of the buck mode and boost mode, the control logic 136 loop controls the inductor current IL rippling between the peak current IL_{PEAK} and the valley current IL_{VALLEY} within a range/window of the ripple (hysteretic) current. For example, the ripple current falls below or stays unchanged at I_{HYS} during T_{CON} when Vₒᵤₜ is greater than or equal to Vᵢₙ while may keep increasing to I_{HYS} plus an additional increment during T_{CON} when Vₒᵤₜ is less than Vᵢₙ as shown in FIGS. 3 and 5.

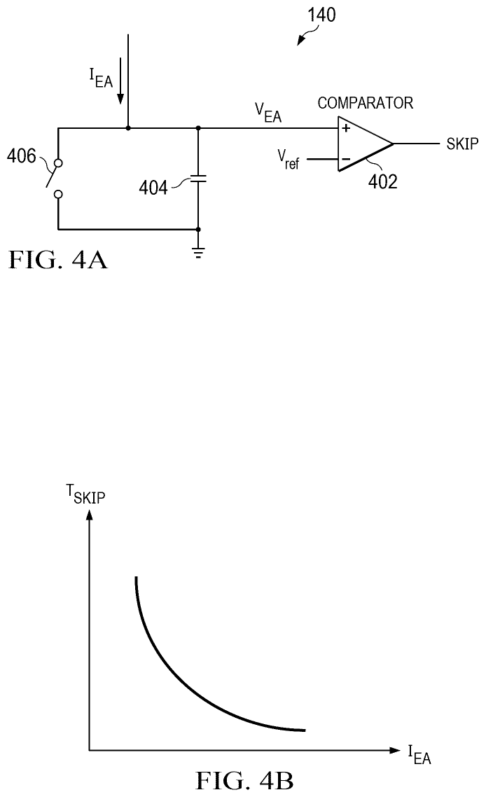

In one example, the hysteretic current mode buck-boost converter 100 includes a skip timer 140 configurable to accept the second current I_{EA} generated from the output voltage Vₒᵤₜ as its input, and to generate an output to the control logic 136 to keep the inductance current IL at its current level, e.g., the second current I_{EA} for a certain period of time T_{SKIP}. FIG. 4A depicts an example of a schematic diagram of an implementation of the skip timer 140 in FIG. 1, and FIG. 4B depicts the relationship between the second current I_{EA} and the skip period of time T_{SKIP}. As shown by the example of FIG. 4A, the skip timer 140 includes a voltage comparator 402, which takes the voltage V_{EA} at charging capacitor C 404 charged by the second current I_{EA} as its first input and a reference voltage V_{REF} as its second input to generate a skip signal to the control logic 136. The relationship between I_{EA}, V_{EA}, and T_{SKIP} can be expressed as:

$${I}_{E A} / C = {V}_{E A} / {T}_{SKIP} , or {T}_{SKIP} = {V}_{EA} * C / {I}_{E A}$$

i.e., the skip period of time T_{SKIP} is reversely proportional to the second current I_{EA} generated from the output voltage Vₒᵤₜ as shown by the FIG. 4B. In one example, the charging capacitor C 404 is reset via a switch 406 when the T_{SKIP} period is over and the inductance current IL rises again. FIG. 5 depicts examples of waveforms of the inductor current IL over time under the buck mode, the buck-boost mode, and the boost mode, respectively, with the skip timer 140 skips the skip period of time T_{SKIP}. Note that the start and end points of the skip timer shown in FIG. 5 are examples for illustrative purposes only as the skip period of time T_{SKIP} may start and/or end at any point. For a nonlimiting example, in continuous conducting mode (CCM), the skip period of time T_{SKIP} may end before T_{OFF} ends.

In this description, the term “coupled” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. An apparatus comprising:
a current source configurable to provide a first current at a pre-determined current value;
a first current comparator configurable to
receive a rising current through an inductor as a first input of the first current comparator and the first current plus a second current as a second input of the first current comparator; and
provide an output to a control logic based on comparison between the first input and the second input of the first current comparator;
a second current comparator configurable to
receive the second current as a first input of the second current comparator and a falling current through the inductor as a second input of the second current comparator; and
provide an output to the control logic based on comparison between the first input and the second input of the second current comparator; and
the control logic configurable to control an inductor current through the inductor by switching one or more of a plurality of transistors based on the outputs from the first current comparator and the second current comparator.

2. The apparatus of claim 1, wherein:
the inductor current through the inductor equals to either the rising current or the falling current through the inductor.

3. The apparatus of claim 1, wherein:
the control logic is configurable to bound the inductor current to be within a range between the second current and the first current plus the second current.

4. The apparatus of claim 1, wherein:
the control logic is configurable to control a duty cycle by extending a first time period when the inductor current is rising and/or a second time period when the inductor current is falling.

5. The apparatus of claim 4, further comprising:
a constant timer configurable to provide an output to the control logic to hold the inductor current close to its current level for a certain period of time between the first time period when the inductor current is rising and the second time period when the inductor current is falling.

6. The apparatus of claim 1, further comprising:
a skip timer configurable to
accept the second current as its input; and
generate an output to the control logic to keep the inductance current at level of the second current for a certain period of time.

7. The apparatus of claim 1, wherein the plurality of transistors include:
a first transistor coupled between an input voltage terminal and a first terminal;
a second transistor coupled between the first terminal and a ground terminal;
a third transistor coupled between a second terminal and an output voltage terminal; and
a fourth transistor coupled between the second terminal and the ground terminal.

8. The apparatus of claim 7, wherein:
said inductor is coupled between the first terminal and the second terminal.

9. The apparatus of claim 7, wherein:
the second current is generated according to an output voltage at the output voltage terminal.

10. The apparatus of claim 7, further comprising:
a mode controller configurable to
accept an input voltage from the input voltage terminal and an output voltage from the output voltage terminal as its two inputs; and
generate an output to the control logic to switch one or more of the first, the second, the third, and the fourth transistors among a buck mode, a boost mode, and a buck-boost mode.

11. The apparatus of claim 10, wherein:
the control logic is configurable to, during the buck mode,
turn on the third transistor;
turn off the fourth transistor; and
switch between the first and the second transistors according to the rising current, the falling current, the first current, and the second current.

12. The apparatus of claim 10, wherein:
the control logic is configurable to, during the boost mode,
turn on the first transistor;
turn off the second transistor; and
switch between the third and the fourth transistors according to the rising current, the falling current, the first current, and the second current.

13. The apparatus of claim 10, wherein:
the control logic is configurable to, during the buck-boost mode, switch between the first, the second, the third, and the fourth transistors according to the rising current, the falling current, the first current, and the second current.

14. A method, comprising:
generating a first current at a pre-determined current value;
receiving a rising current through an inductor as a first input of a first current comparator and the first current plus a second current as a second input of the first current comparator;
providing an output to a control logic based on comparison between the first input and the second input of the first current comparator;
receiving the second current as a first input of a second comparator and a falling current through the inductor as a second input of the second current comparator;
providing an output to the control logic based on comparison between the first input and the second input of the second current comparator; and
controlling an inductor current through the inductor by switching one or more of a plurality of transistors based on the outputs from the first current comparator and the second current comparator.

15. The method of claim 14, further comprising:
bounding the inductor current within a range between the second current and the first current plus the second current.

16. The method of claim 14, further comprising:
controlling a duty cycle by extending a first time period when the inductor current is rising (Ton) and/or a second time period when the inductor current is falling (Toff).

17. The method of claim 16, further comprising:
holding the inductor current close to its current level for a certain period of time between the first time period when the inductor current is rising and the second time period when the inductor current is falling.

18. The method of claim 14, further comprising:
keeping the inductance current at level of the second current for a certain period of time.

19. The method of claim 14, further comprising:
generating the second current according to an output voltage at an output voltage terminal.

20. The method of claim 14, further comprising:
generating an output to the control logic to switch one or more of the plurality of transistors between a buck mode, a boost mode, and a buck-boost mode using an input voltage from an input voltage terminal and an output voltage from the output voltage terminal as inputs.

21. The method of claim 20, further comprising:
turning on one of the plurality of transistors;
turning off one of the plurality of transistors; and
switching between two of the plurality of transistors according to the rising current, the falling current, the first current, and the second current during the buck mode and the boost mode.

22. The method of claim 20, further comprising:
switching between the plurality of transistors according to the rising current, the falling current, the first current, and the second current during the buck-boost mode.
